(19) United States
(12) Patent Application Publication
(10) Pub. No.: US 2017/0043531 A1
(43) Pub. Date: Feb. 16, 2017

(54) Method of Manufacturing Marine Hose and Marine Hose

(71) Applicant: The Yokohama Rubber Co., LTD., Minato-ku, Tokyo (JP)

(72) Inventor: Tomohiro Morita, Hiratsuka-shi, Kanagawa (JP)

(21) Appl. No.: 15/306,748

(22) PCT Filed: Apr. 21, 2015
(86) PCT No.: PCT/JP2015/062069

§ 371 Date: Oct. 25, 2016

(30) Foreign Application Priority Data
Apr. 25, 2014 (JP) 2014-090950

(51) Int. Cl. B29C 65/00; B32B 5/18; F16L 11/133; B32B 25/14; B32B 25/04; B32B 37/15; B32B 1/08; B32B 25/12

(52) U.S. Cl. CPC B29C 66/73752; B32B 1/08; B32B 5/18; B32B 25/12; B32B 25/14; B32B 25/045; B32B 37/15; B29C 66/727; B29C 66/5326; F16L 11/133; B29K 2609/06

(57) ABSTRACT

A method of manufacturing a marine hose that at least a base hose, a sponge layer, a foam rubber layer, and a cover rubber layer. The method comprises the steps of: wrapping a sponge layer around the outside of the base hose; wrapping a foam rubber layer around the outside of the sponge layer, the foam rubber layer containing an unvulcanized foam rubber composition; wrapping a cover rubber layer around the outside of the foam rubber layer; and vulcanizing the wrapped assembly; wherein the foam rubber composition includes a rubber component containing as a main component at least one selected from the group consisting of natural rubber, styrene butadiene rubber, chloroprene rubber, ethylene propylene rubber, ethylene propylene diene rubber, and reclaimed rubber.

### TECHNICAL FIELD

The present technology relates to a method of manufacturing a marine hose and a marine hose, and particularly relates to a method of manufacturing a marine hose that includes a sponge layer and has good appearance, and a marine hose that includes a sponge layer and has good appearance.

### BACKGROUND ART

Conventional marine hoses (floating type and submarine type marine hoses) are typically formed by vulcanizing a base hose with a closed cell sponge, such as a natural rubber sponge or a polyethylene sponge, wrapped around the outside of the base hose (for example, see Japanese Unexamined Patent Application Publication No. 2006-283788A).

However, the heat during vulcanization causes the sponge in the marine hose to shrink. This results in a wrinkled appearance of the formed marine hose. Japanese Unexamined Patent Application Publication No. 2006-283788A describes a marine hose that includes a sponge layer and a foam rubber layer. However, this hose too can suffer from a wrinkled appearance.

### SUMMARY

The present technology provides a method of manufacturing a marine hose that includes a sponge layer and has good appearance and a marine hose that includes a sponge layer and has good appearance.

A method of manufacturing a marine hose, which includes at least a base hose, a sponge layer, a foam rubber layer, and a cover rubber layer, comprises the steps of:

wrapping a sponge layer A around the outside of the base hose;

wrapping a foam rubber layer B around the outside of the sponge layer A, the foam rubber layer B containing an unvulcanized foam rubber composition;

wrapping a cover rubber layer around the outside of the foam rubber layer B; and

vulcanizing the wrapped assembly; wherein

the foam rubber composition includes

a rubber component containing as a main component at least one selected from the group consisting of natural rubber, styrene butadiene rubber, chloroprene rubber, ethylene propylene rubber, ethylene propylene diene rubber, and reclaimed rubber;

and, per 100 parts by mass of the rubber component, from 1.1 to 50 parts by mass of a blowing agent and from 1.1 to 50 parts by mass of a blowing aid; and

a blow ratio of the foam rubber composition after vulcanization is 1.1 or greater.

The method of manufacturing a marine hose of the present technology includes wrapping the foam rubber layer B, which contains a specific foam rubber composition, around the outside of the sponge layer A. Upon vulcanization, this foam rubber composition expands, offsetting the thermal shrinkage of the sponge layer A. As a result, wrinkles are prevented from forming on the outer surface of the marine hose.

The foam rubber layer C, which contains an unvulcanized foam rubber composition, can be wrapped around the outside of the base hose prior to the sponge layer A being wrapped. Additionally, the sponge layer D, another sponge layer, can be wrapped around the outside of the sponge layer A prior to the foam rubber layer B being wrapped. Such a configuration can provide the marine hose with even better appearance.

The blowing agent is preferably at least one selected from the group consisting of an azo compound, a nitroso compound, a sulfonyl hydrazide compound, an azide compound, and an inorganic blowing agent.

A marine hose manufactured by the method of manufacturing described above is capable of preventing wrinkles forming on the outside of the marine hose and have good appearance.

### BRIEF DESCRIPTION OF DRAWING

FIG. 1 is a schematic cross-sectional view of a portion that exemplifies an embodiment of a marine hose of the present technology.

### DETAILED DESCRIPTION

Hereinafter, a method of manufacturing a marine hose according to the present technology will be described on the basis of an embodiment that is illustrated in the drawing.

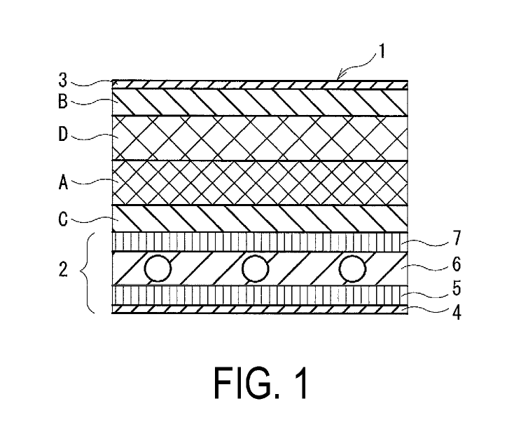

FIG. 1 is a schematic cross-sectional view of a portion of a marine hose body, which is an example of an embodiment of the structure of the marine hose manufactured by the method of manufacturing of the present technology.

In FIG. 1, a marine hose 1, along a cross section thereof, includes a base hose 2, a sponge layer A, D, a foam rubber layer B, C, and a cover rubber layer 3. In the example of FIG. 1, the foam rubber layer C, the sponge layer A, the sponge layer D, and the foam rubber layer B are disposed outward of the base hose 2 in that order. However, the structure of the marine hose 1 is not limited to the structure of the example illustrated in the drawing. The marine hose 1 is only required to have a configuration including at least one sponge layer A disposed outward of the base hose 2, the foam rubber layer B disposed outward of the sponge layer A, and the cover rubber layer 3 disposed outward of the foam rubber layer B. For example, the foam rubber layer C may be disposed between the base hose 2 and the sponge layer A, forming a configuration of the base hose 2, the foam rubber layer C, the sponge layer A, the foam rubber layer B, and the cover rubber layer 3. Additionally, the sponge layer D may be disposed between the sponge layer A and the foam rubber layer B, forming a configuration of the base hose 2, the sponge layer A, the sponge layer D, the foam rubber layer B, and the cover rubber layer 3.

The base hose 2 may have a structure in common with those typically used in marine hoses. Such a structure is exemplified by a hose including, from the inner side, a tube rubber layer 4, a reinforcing layer 5, a wire reinforcing layer 6, and a reinforcing layer 7. The cover rubber layer 3 is a layer for protecting the outer surface of the marine hose. A cover rubber layer typically used in marine hoses can be applied.

The sponge layers A, D can be made of sponge typically used in marine hoses. Examples of such include natural rubber sponges, polyethylene sponges, urethane sponges, and synthetic rubber sponges. Natural rubber sponges and polyethylene sponges are preferable. When a marine hose comprising a natural rubber sponge is vulcanized, the natural rubber sponge can adhere to the base hose without requiring the use of an adhesive.

In the present technology, the sponge layers A, D may be either closed cell or open cell. A closed cell sponge is preferable. Closed cell sponge layers A, D provide buoyancy of the marine hose while also allowing a sufficient level of strength to be maintained.

The method of manufacturing of the present technology includes wrapping the sponge layer A around the outside of the base hose 2, wrapping the foam rubber layer B, which contains an unvulcanized foam rubber composition, around the outside of the sponge layer A, wrapping the cover rubber layer 3 around the outside of the foam rubber layer B, and vulcanizing the wrapped assembly. By virtue of this configuration, when the sponge layer A undergoes thermal shrinkage during vulcanization, the foam rubber composition concurrently vulcanizes and expands. As a result, the amount of thermal shrinkage that the sponge layer A undergoes is offset and wrinkles can be prevented from forming on the outer surface of the marine hose 1.

Additionally, the foam rubber layer C, which contains an unvulcanized foam rubber composition, can be wrapped around the outside of the base hose 2 prior to the sponge layer A being wrapped. Additionally, the sponge layer D, another sponge layer, can be wrapped around the outside of the sponge layer A prior to the foam rubber layer B being wrapped. Such a configuration can provide the marine hose 1 with even better appearance.

The blow ratio of the foam rubber composition upon vulcanization of the marine hose must be 1.1 or greater. The blow ratio is preferably from 1.5 to 30, and more preferably from 1.5 to 15. A blow ratio of less than 1.1 results in the thermal shrinkage of the sponge layers A, D being unable to be sufficiently offset and wrinkles forming on the outer surface of the marine hose. On the other hand, an excessively large blow ratio results in the foam rubber layers B, C having insufficient strength. Note that in the present specification, the blow ratio is found by measuring the density of the foam rubber composition before and after expansion and taking the ratio of the two (density before expansion/density after expansion).

In the method of manufacturing of the present technology, the foam rubber composition that makes up the foam rubber layers B, C may be the same composition or different, with the proviso that the composition is one of those described below. Typically, to increase productivity, use of the same composition is preferable.

The foam rubber composition that makes up the foam rubber layers B, C contains a rubber component containing, as a main component, at least one selected from the group consisting of natural rubber, styrene butadiene rubber, chloroprene rubber, ethylene propylene rubber, ethylene propylene diene rubber, and reclaimed rubber; and, per 100 parts by mass of the rubber component, from 1.1 to 50 parts by mass of a blowing agent, and from 1.1 to 50 parts by mass of a blowing aid.

The rubber component of the foam rubber composition contains, as a main component, at least one selected from the group consisting of natural rubber, styrene butadiene rubber, chloroprene rubber, ethylene propylene rubber, ethylene propylene diene rubber, and reclaimed rubber. Here, “main component” means that at least one rubber selected from the group consisting of natural rubber, styrene butadiene rubber, chloroprene rubber, ethylene propylene rubber, ethylene propylene diene rubber, and reclaimed rubber has a total content of 50 wt. % or greater with respect to the 100 wt. % rubber component. The total content of rubber selected from natural rubber, styrene butadiene rubber, and reclaimed rubber is preferably 50 wt. % or greater. Here, reclaimed rubber should be understood as containing carbon black and other such fillers and compounding agents as well as rubber components. Thus, the content of the reclaimed rubber should be determined by the actual amount of the rubber components contained in the reclaimed rubber. Note that the reclaimed rubber is preferably made of natural rubber.

The foam rubber composition contains from 1.1 to 50 parts by mass, and preferably from 1.1 to 20 parts by mass of the blowing agent per 100 parts by mass of the rubber component. A foam rubber composition containing less than 1.1 parts by mass of the blowing agent expands insufficiently upon vulcanization and results in the blow ratio being unable to be made high enough to enable the thermal shrinkage of the sponge layer to be sufficiently offset. On the other hand, a foam rubber composition containing more than 50 parts by mass of the blowing agent has increased cost without an increase in the blow ratio.

Examples of the blowing agent include a chemical blowing agent and an inorganic blowing agent. Examples of the chemical blowing agent include an azo compound, a nitroso compound, a sulfonyl hydrazide compound, an azide compound, and a carbon diamide compound. Of these, an azo compound is preferable. One of these chemical blowing agents may be used individually or two or more may be used together.

Examples of the nitroso compound include N,N′-dinitroso-pentamethylene tetramine (DPT), and N,N′-dimethyl-N,N′-dinitroso-terephthalamide. Examples of the azo compound include azobisisobutyronitrile (AZBN), azobiscyclohexylnitrile, and azodiaminobenzene, bariumazodicarboxylate. Examples of the carbon diamide compound include azodicarbonamide (ADCA). Examples of the sulfonyl hydrazide compound include benzenesulfonylhydrazide (BSH), 4,4′-oxybis(benzenesulfonylhydrazide)(OBSH), toluenesulfonylhydrazide (TSH), and diphenylsulfone-3,3′-disulfonylhydrazide. Examples of the azide compound include calciumazide, 4,4′-diphenyldisulfonylazide, and p-toluenesulfonylazide.

A decomposition temperature of the chemical blowing agent is preferably from 120 to 200° C. and more preferably from 130 to 170° C. A chemical blowing agent with a decomposition temperature within this range facilitates chemical blowing and vulcanization control. In the present specification, the decomposition temperature of the chemical blowing agent is a temperature determined by measuring decomposition heat and weight decrease using a heat analysis method selected from differential scanning calorimetry (DSC) and thermogravimetry (TGA).

Examples of the inorganic blowing agent include carbon dioxide, air, nitrogen, water, ammonia, sodium hydrogen carbonate, anhydrous sodium nitrate, sodium bicarbonate, sodium carbonate, ammonium bicarbonate, ammonium carbonate, and ammonium nitrite. Carbon dioxide, carbon monoxide, nitrogen, air, and ammonia are preferable. One of these inorganic blowing agents may be used individually or two or more may be used together.

The foam rubber composition contains from 1.1 to 50 parts by mass, and preferably from 1.1 to 20 parts by mass of the blowing aid per 100 parts by mass of the rubber component. A foam rubber composition containing less than 1.1 parts by mass of the blowing aid expands insufficiently upon vulcanization and results in the blow ratio being unable to be made high enough. On the other hand, a foam rubber composition containing more than 50 parts by mass of the blowing aid has increased cost without an increase in the blow ratio.

Examples of the blowing aid include a urea blowing aid, a salicylic acid blowing aid, a benzoic acid blowing aid, and a metal oxide (such as zinc oxide). A urea blowing aid and a metal oxide are preferable. The blowing aid used is dependent upon the blowing agent used. For example, when azodicarbonamide (ADCA) is used as the blowing agent, urea can be used as the blowing aid. One of these blowing aids may be used individually or two or more may be used together.

In the method of manufacturing of the present technology, a ratio (Ta/Tb) between the thickness (Ta) of the sponge layer A and the thickness (Tb) of the unvulcanized foam rubber composition sheet prior to vulcanizing the foam rubber layer B is preferably from 1.5 to 300, and more preferably from 5 to 100. A thickness ratio (Ta/Tb) greater than 300 results in the thermal shrinkage of the sponge layer being unable to be sufficiently offset and wrinkles forming on the outer surface of the marine hose.

The present technology is further described below using examples. However, the scope of the present technology is not limited to these examples.

### Examples

Nine marine hoses (Working Examples 1 to 7, Comparative Examples 1 to 2) were manufactured according to the different foam rubber compositions shown in Table 1. Each of the marine hoses was manufactured by wrapping the sponge layer A around the outside of the base hose, wrapping the sponge layer D around the outside of the sponge layer A, wrapping an unvulcanized foam rubber composition sheet around the outside of the sponge layer D, wrapping the cover rubber layer around the outside of the unvulcanized foam rubber composition sheet, and wrapping fabric around this wrapped assembly. Then this wrapped assembly was vulcanized at 127° C. for 210 minutes.

Note that the sponge layers A, D were each constituted by a 60 mm-thick polyethylene sponge wrapped around a single time. The unvulcanized foam rubber composition sheet of predetermined thickness was wrapped around the outside of the sponge layer D a single time. In Working Examples 1 to 6 and Comparative Examples 1 to 2, the thickness (Ta) of the sponge layer A was 60 mm, the thickness (Tb) of the unvulcanized foam rubber composition sheet was 4 mm, and the thickness ratio thereof (Ta/Tb) was 15. In Working Example 7, the thickness (Ta) of the sponge layer A was 60 mm, the thickness (Tb) of the unvulcanized foam rubber composition sheet was 0.194 mm, and the thickness ratio thereof (Ta/Tb) was 310.

Whether or not the obtained marine hoses had a wrinkled appearance is shown in Table 1. Blow ratio was determined by finding the ratio of the density of the unvulcanized foam rubber composition sheet to the density of the foam rubber layer B, which was found by taking out the foam rubber layer B from the marine hose and measuring its density. The obtained blow ratios are shown in Table 1.

TABLE 1-1

| | | Working | Working | Working | Working | Working |
|---|---|---|---|---|---|---|
| | | Example | Example | Example | Example | Example |
| | | 1 | 2 | 3 | 4 | 5 |
| NR | Part by mass | 70 | 70 | 70 | 50 | 100 |
| SBR | Part by mass | 30 | 30 | 30 | 50 | |
| Reclaimed rubber | Part by mass | | | | | |
| Carbon black | Part by mass | 10 | 10 | 10 | 10 | 10 |
| Calcium carbonate | Part by mass | 60 | 60 | 60 | 60 | 60 |
| Zinc oxide | Part by mass | 5 | 5 | 5 | 5 | 5 |
| Stearic acid | Part by mass | 2 | 2 | 2 | 2 | 2 |
| Wax | Part by mass | 5 | 5 | 5 | 5 | 5 |
| Aroma oil | Part by mass | 15 | 15 | 15 | 15 | 15 |
| Sulfur | Part by mass | 3 | 3 | 3 | 3 | 3 |
| Vulcanization | Part by mass | 1 | 1 | 1 | 1 | 1 |
| accelerator | | | | | | |
| Blowing agent | Part by mass | 5 | 3 | 7 | 5 | 7 |
| Blowing aid | Part by mass | 5 | 3 | 7 | 5 | 7 |
| Blow ratio | — | 1.5 | 1.4 | 1.8 | 1.8 | 1.8 |
| Thickness ratio | — | 15 | 15 | 15 | 15 | 15 |
| (Ta/Tb) | | | | | | |
| Appearance | — | No | No | No | No | No |
| (presence of wrinkles) | | | | | | |

| | | Working | Comparative | Comparative | Working |
|---|---|---|---|---|---|
| | | Example 6 | Example 1 | Example 2 | Example 7 |
| NR | Part by mass | 50 | 70 | 70 | 70 |
| SBR | Part by mass | | 30 | 30 | 30 |
| Reclaimed rubber | Part by mass | 100 | | | |
| Carbon black | Part by mass | 10 | 10 | 10 | 10 |
| Calcium carbonate | Part by mass | 60 | 60 | 60 | 60 |
| Zinc oxide | Part by mass | 5 | 5 | 5 | 5 |
| Stearic acid | Part by mass | 2 | 2 | 2 | 2 |
| Wax | Part by mass | 5 | 5 | 5 | 5 |
| Aroma oil | Part by mass | 15 | 15 | 15 | 15 |
| Sulfur | Part by mass | 3 | 3 | 3 | 3 |
| Vulcanization | Part by mass | 1 | 1 | 1 | 1 |
| accelerator | | | | | |
| Blowing agent | Part by mass | 5 | 0 | 1 | 3 |
| Blowing aid | Part by mass | 5 | 0 | 1 | 3 |
| Blow ratio | — | 1.9 | 1.0 | 1.0 | 1.4 |
| Thickness ratio | — | 15 | 15 | 15 | 310 |
| (Ta/Tb) | | | | | |
| Appearance (presence | — | No | Yes | Yes | Some |
| of wrinkles) | | | | | |

The raw materials used as per Table 1 are described below.

NR (natural rubber): STR-20
SBR: styrene butadiene rubber, Asaprene 303 manufactured by Japan Elastomer Co., Ltd., non-oil extended product

Reclaimed rubber: reclaimed rubber of 50 wt. % rubber component content, Muraoka Rubber Reclaiming Co., Ltd.

Carbon black: HTC #100 manufactured by NSCC Carbon Co., Ltd.

Calcium carbonate: calcium carbonate manufactured by Maruo Calcium Co., Ltd.

Zinc oxide: Zinc Oxide #3 manufactured by Seido Chemical Industry Co., Ltd. Stearic acid: stearic acid YR manufactured by NOF CORPORATION

Wax: SUNTIGHT R manufactured by Seiko Chemical Co., Ltd.

Aroma oil: A-OMIX manufactured by Sankyo Yuka Kogyo K.K.

Sulfur: Oil Treated Sulfur, manufactured by Hosoi Chemical Industry Co., Ltd.

Vulcanization accelerator: Nocceler DM manufactured by Ouchi Shinko Chemical Industrial Co., Ltd.

Blowing agent: VINYFOR-AC-3 manufactured by EIWA CHEMICAL IND. CO. LTD.

Blowing aid: CELLPASTE-M3 manufactured by EIWA CHEMICAL IND. CO. LTD.

The marine hoses obtained by the method of manufacturing of Working Examples 1 to 7 had no wrinkles on the outer surface thereof and had good appearance.

In the method of manufacturing of Comparative Example 1, a blowing agent and a blowing aid were not added to the foam rubber composition. Thus upon vulcanization, expansion did not take place and wrinkles formed on the outer surface of the marine hose. In the method of manufacturing of Comparative Example 2, a blowing agent and the blowing aid were added to the foam rubber composition at an amount of less than 1.1 parts by mass. Thus upon vulcanization, expansion did not take place and wrinkles formed on the outer surface of the marine hose.

1. A method of manufacturing a marine hose that includes at least a base hose, a sponge layer, a foam rubber layer, and a cover rubber layer, the method comprising the steps of:
wrapping a sponge layer (A) around the outside of the base hose;
wrapping a foam rubber layer (B) around the outside of the sponge layer (A), the foam rubber layer (B) containing an unvulcanized foam rubber composition;
wrapping a cover rubber layer around the outside of the foam rubber layer (B); and
vulcanizing the wrapped assembly; wherein
the foam rubber composition includes
a rubber component containing as a main component at least one selected from the group consisting of natural rubber, styrene butadiene rubber, chloroprene rubber, ethylene propylene rubber, ethylene propylene diene rubber, and reclaimed rubber;
and, per 100 parts by mass of the rubber component, from 1.1 to 50 parts by mass of a blowing agent and from 1.1 to 50 parts by mass of a blowing aid; and
a blow ratio of the foam rubber composition after vulcanization is 1.1 or greater.

2. The method of manufacturing a marine hose according to claim 1, further comprising wrapping a foam rubber layer (C) around the outside of the base hose prior to wrapping the sponge layer (A), the foam rubber layer (C) containing an unvulcanized foam rubber composition.

3. The method of manufacturing a marine hose according to claim 1, further comprising wrapping another sponge layer (B) around the outside of the sponge layer (A) prior to wrapping the foam rubber layer (B).

4. The method of manufacturing a marine hose according to claim 1, wherein the blowing agent is at least one selected from the group consisting of an azo compound, a nitroso compound, a sulfonyl hydrazide compound, an azide compound, and an inorganic blowing agent.

5. A marine hose manufactured by the method of manufacturing a marine hose according to claim 1.

6. The method of manufacturing a marine hose according to claim 2, further comprising wrapping another sponge layer (B) around the outside of the sponge layer (A) prior to wrapping the foam rubber layer (B).

7. The method of manufacturing a marine hose according to claim 6, wherein the blowing agent is at least one selected from the group consisting of an azo compound, a nitroso compound, a sulfonyl hydrazide compound, an azide compound, and an inorganic blowing agent.

8. A marine hose manufactured by the method of manufacturing a marine hose according to claim 7.
